(19) United States
(12) Patent Application Publication
(10) Pub. No.: US 2008/0318099 A1
(43) Pub. Date: Dec. 25, 2008

(54) Apparatus for preventing carbon corrosion at cathod in fuel cell

(75) Inventors: Seung Chan Oh, Gyeonggi-do (KR); Jong Hyun Lee, Gyeongsangbuk-do (KR); Jong Jin Yoon, Seoul (KR); Jae Jun Ko, Gyeonggi-do (KR); Young Min Kim, Gyeonggi-do (KR); Ik Jae Son, Gyeonggi-do (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 11/986,920

(22) Filed: Nov. 27, 2007

(30) Foreign Application Priority Data
Jun. 21, 2007 (KR) 10-2007-0060912

(51) Int. Cl. H01M 8/04

(52) U.S. Cl. 429/25; 137/511

(57) ABSTRACT

The present invention provides an apparatus for effectively preventing carbon corrosion from occurring at the cathode of a fuel cell. The present apparatuses include an air blower supplying air from an air supply source to a fuel cell; a fuel cell receiving air from the air blower to generate electricity by a chemical reaction; an air discharge pipe through which residual air remaining after oxygen of the air is consumed for chemical reaction in the fuel cell is discharged; a pressure sensor provided in the air discharge pipe for detecting air pressure in the fuel cell; an air discharge solenoid valve provided in the air discharge pipe for controlling air flow of the air discharge pipe; and a controller controlling operation of the air blower and the air discharge solenoid valve by receiving a signal detected by the pressure sensor wherein the controller detects the air pressure through the pressure sensor to allow the air blower to supply air to the fuel cell until the air pressure reaches a predetermined pressure and then closes the air discharge solenoid valve until the oxygen in the fuel cell is completely exhausted, thereby preventing the formation of hydrogen/oxygen interface at the anode of the fuel cell.

### CROSS-REFERENCE TO RELATED APPLICATION

This application claims the benefit under 35 U.S.C. §119(a) on Korean Patent Application No. 10-2007-0060912, filed on Jun. 21, 2007, the entire contents of which are incorporated herein by reference.

### BACKGROUND

(a) Technical Field

The present invention relates to an apparatus for preventing carbon corrosion at the cathode of a fuel cell by preventing formation of hydrogen/oxygen interface at the anode of the fuel cell during startup and shutdown of the fuel cell.

(b) Background Art

A fuel cell used as a main power source of a fuel cell vehicle generates electricity by reaction of oxygen supplied from air with hydrogen stored in a fuel tank of the vehicle.

FIG. 1 is a schematic diagram of a fuel cell system in a fuel cell vehicle. The fuel cell 10 includes a separator 11, an anode 12, an electrolyte membrane 13, a cathode 14, a hydrogen/oxygen/coolant distribution structure 15, an anode flow field 16, a cathode flow field 17, and a coolant flow field 18.

During operation of the fuel cell 10, hydrogen is supplied from a hydrogen supply source 19 to the anode flow field 16 through a hydrogen supply solenoid valve 20 and a pipe 38.

To increase the usage rate of hydrogen, hydrogen in the fuel cell 10 is recirculated. More particularly, unreacted hydrogen is transferred to a pipe 23 by operation of a hydrogen recirculation blower 22 while a purge valve 21 is closed, and then returned to the anode flow field 16 through the hydrogen recirculation blower 22 and a hydrogen recirculation control valve 24.

The hydrogen purge valve 21 is opened at a predetermined time and for a predetermined period of time to discharge nitrogen and moisture that flow to the anode through the electrolyte membrane 13.

Oxygen is supplied from the ambient air 46 to an air blower 26 through a pipe 25, and the air blower 26 controls the flow of air to supply the air to the cathode flow field 17 through a pipe 27.

Hydrogen (H₂) at the anode flow field 16 is split into hydrogen ions (H⁺) and electrons (e⁻) by a catalyst of the anode 12, and the hydrogen ions are transferred to the cathode 14 through the electrolyte membrane 13.

Oxygen (O₂) at the cathode flow field 17 is split into oxygen ions (O⁻) by a catalyst of the cathode 14, and the hydrogen ions (H⁺) transferred from the anode and the oxygen ions (O⁻) are reacted to form H₂O.

Oxygen supplied to the cathode flow field 17 is consumed in the reaction and thereby the cathode flow field 17 has an oxygen concentration lower than that of the ambient air (i.e., there is much more nitrogen present). The resulting air in the cathode flow field 17 is discharged through an air discharge pipe 28.

The fuel cell 10 is cooled by a coolant supplied to the coolant flow field 18. In order to maintain the optimum temperature of the fuel cell, a coolant pump 29 is provided. That is, the coolant in the coolant flow field 18 cools the fuel cell 10 and is heated. The coolant of an increased temperature is fed into the coolant pump 29 through a pipe 30 and then introduced into a heat exchanger 32 through a pipe 31 for cooling.

The cooled coolant is fed back into the coolant flow field 18 by way of a pipe 33, a coolant control valve 34, and a pipe 35 to cool the fuel cell 10.

However, when oxygen in the air is fed into the anode flow field 16 during startup and shutdown of the fuel cell 10, the hydrogen/oxygen interface is partially is formed in the fuel cell as shown in FIG. 2 (U.S. Patent Application Publication No. 2003/0134165 A1) to corrode a carbon support material at the cathode, thus degrading the performance of the fuel cell.

Various apparatuses and methods for reducing the performance degradation due to the formation of hydrogen/oxygen interface during startup and shutdown of the fuel cell have been proposed, which are summarized as follows:

### 1. Adding a Devices Such As:

1) a resistance (U.S. Patent Application Publication No. 2003/0134165 A1);

2) a gas burner (U.S. Patent Application Publication No. 2003/0031966 A1);

3) a plurality of hydrogen gas burners in a hydrogen recirculation blower (U.S. Patent Application Publication No. 2003/0129462 A1); and

4) a nitrogen bomb.

### 2. Fuel Cell Startup/Shutdown Process Such As:

1) purging nitrogen at the anode and purging air during fuel cell shutdown (U.S. Patent Application Publication No. 2003/0134165 A1);

2) supplying hydrogen first to the anode during startup (U.S. Patent Application Publication No. 2003/0134165 A1); and

3) removing oxygen by supplying hydrogen into the hydrogen gas burger in the hydrogen recirculation blower (U.S. Patent Application Publication No. 2003/0129462 A1).

However, using the gas burner has a safety problem and requires an additional device. Such an additional device requires much power and space in terms of layout.

Also, using the nitrogen bomb has some problems in that it requires an additional device for mounting the nitrogen bomb in the vehicle and it is necessary to refill the nitrogen bomb when the nitrogen is exhausted.

In addition, purging air during the fuel cell shutdown process, the hydrogen/oxygen interface is inevitably formed at the anode and the hydrogen/oxygen interface shortens the time for which the anode is filled with air, thus degrading the performance of the fuel ell.

Moreover, in the apparatus and method of using the fuel cell startup/shutdown process, it takes much time for startup and shutdown, which results in a problem of inconvenience.

Accordingly, the prior art apparatuses and methods have adverse effects on the durability performance of the fuel cell. Furthermore, if the hydrogen exhaust and the air exhaust are exposed to the air, there is a possibility of causing damage to the fuel cell due to pollutants in the ambient air.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to solve the above problems, and an object of the present invention is to provide an apparatus for preventing carbon corrosion at the cathode of a fuel cell, which can effectively prevent the corrosion of a carbon material at the cathode by preventing the formation of hydrogen/oxygen interface at the anode of the fuel cell during startup and shutdown thereof.

In one aspect, the present invention provides an apparatus for preventing carbon corrosion at the cathode of a fuel cell, the apparatus comprising: an air blower supplying air from an air supply source to a fuel cell; a fuel cell receiving air from the air blower to generate electricity by a chemical reaction; an air discharge pipe through which residual air remaining after oxygen of the air is consumed for chemical reaction in the fuel cell is discharged; a pressure sensor provided in the air discharge pipe for detecting air pressure in the fuel cell; an air discharge solenoid valve provided in the air discharge pipe for controlling air flow of the air discharge pipe; and a controller controlling operation of the air blower and the air discharge solenoid valve by receiving a signal detected by the pressure sensor. The controller detects the air pressure through the pressure sensor to allow the air blower to supply air to the fuel cell until the air pressure reaches a predetermined pressure and then closes the air discharge solenoid valve until the oxygen in the fuel cell is completely exhausted, thereby preventing the formation of hydrogen/oxygen interface at the anode of the fuel cell.

In a preferred embodiment, a pressure relief valve (PRV) is provided between the pressure sensor and the air discharge solenoid valve.

In another preferred embodiment, a storage tank is provided in the air discharge pipe to store water discharged through the air discharge pipe, and a water discharge solenoid valve is provided below the storage tank to discharge the water in the storage tank.

In still another preferred embodiment, the air discharge solenoid valve is equipped with a hot wire for preventing the air discharge solenoid valve from being frozen due to water when the temperature drops below zero.

In yet another preferred embodiment, the water discharge solenoid valve is equipped with a hot wire for preventing the air discharge solenoid valve from being frozen due to water when the temperature drops below zero.

In a further preferred embodiment, an air supply solenoid valve is provided between the air blower and the fuel cell to minimize the amount of air to be consumed for chemical reaction in the fuel cell, thereby reducing the time for which the cathode is filled with nitrogen.

In still a further preferred embodiment, an energy storing and exhausting device is connected to the fuel cell to rapidly exhaust oxygen contained in the air introduced into the fuel cell.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

Other aspects of the invention are discussed infra.

### BRIEF DESCRIPTION OF THE DRAWINGS

FIG. 1 is a schematic diagram of a conventional fuel cell system of a fuel cell vehicle;

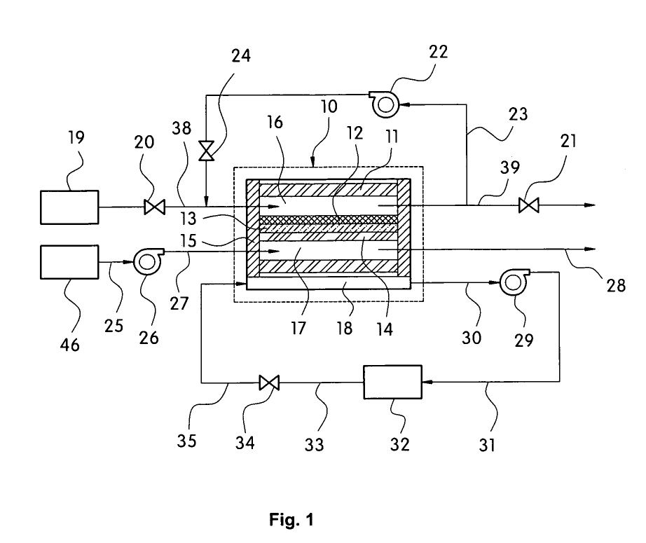

FIG. 2 is a schematic diagram illustrating the formation of hydrogen/oxygen interface in the conventional fuel cell system;

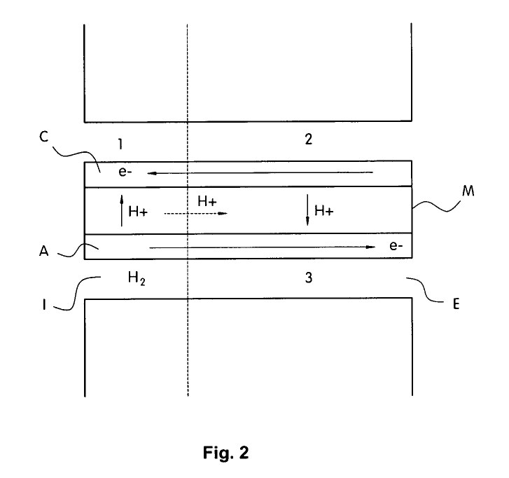

FIG. 3 is a configuration diagram illustrating an apparatus for preventing carbon corrosion at the cathode of a fuel cell in accordance with a preferred embodiment of the present invention;

FIG. 4 is a schematic diagram illustrating a relief valve provided in an air discharge pipe of FIG. 3;

FIG. 5 is a configuration diagram illustrating an apparatus for preventing carbon corrosion at the cathode of a fuel cell in accordance with another embodiment of the present invention;

FIG. 6 is a configuration diagram illustrating an apparatus for preventing carbon corrosion at the cathode of a fuel cell in accordance with a further embodiment of the present invention; and

FIG. 7 is a configuration diagram illustrating an apparatus for preventing carbon corrosion at the cathode of a fuel cell in accordance with still another embodiment of the present invention.

Reference numerals set forth in the Drawings includes reference to the following elements as further discussed below:

10: fuel cell 11: separator

12: anode 13: electrolyte membrane

14: cathode

15: hydrogen/oxygen/coolant distribution structure

16: anode flow field 17: cathode flow field

18: coolant flow field 19: hydrogen supply source

20: hydrogen supply valve 21: purge valve

22: hydrogen recirculation blower

23, 25, 27, 30, 31, 33, 35, 38 and 39: pipes

24: hydrogen recirculation control valve

26: air blower 28: air discharge pipe

29: coolant pump 32: heat exchanger

34: coolant control valve 36: air discharge solenoid valve

37: pressure sensor 40: PRV

41: air discharge solenoid valve equipped with a hot-wire

42: storage tank

43: water discharge solenoid valve equipped with a hot-wire

44: air supply solenoid valve

45: energy storing and exhausting device

46: air

### DETAILED DESCRIPTION

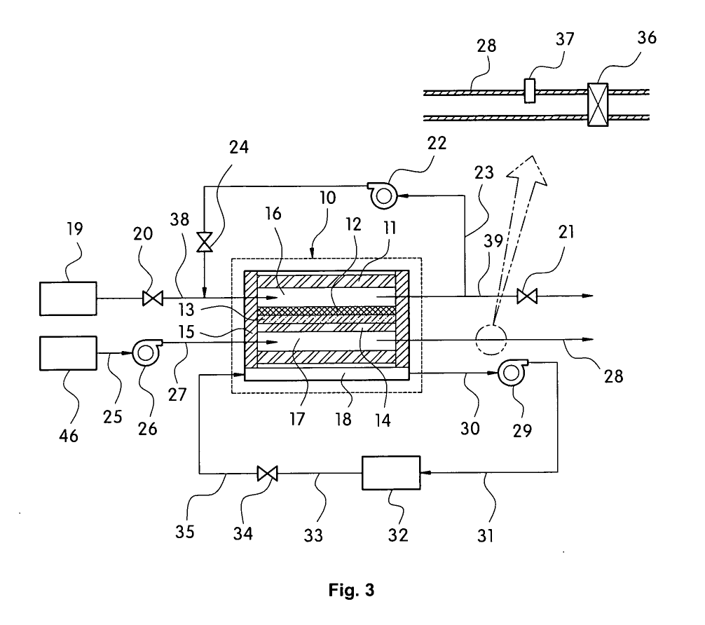

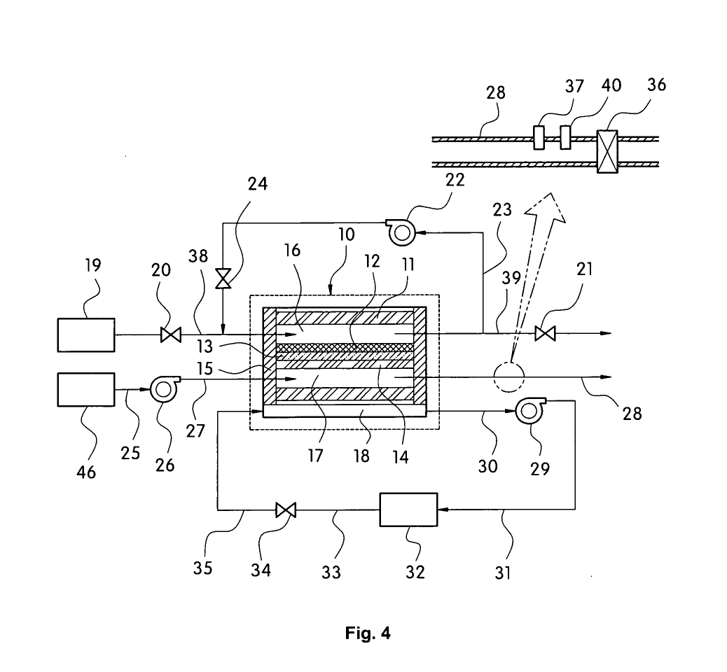

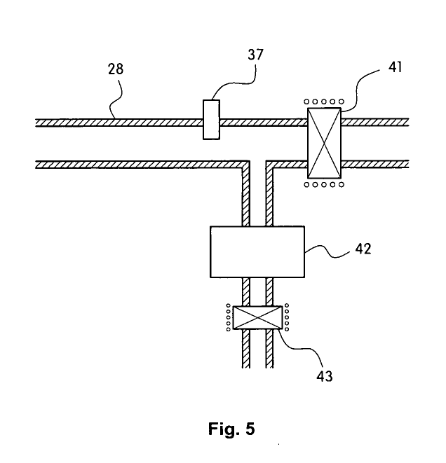

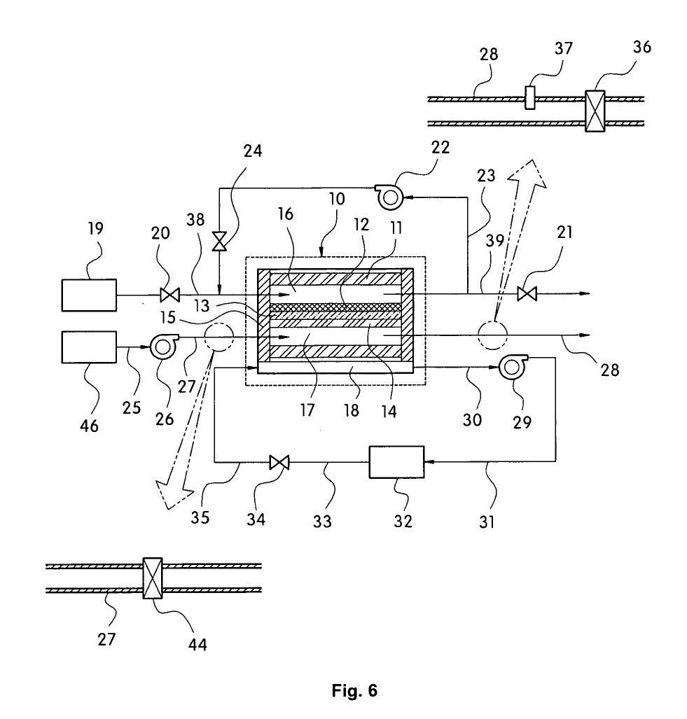

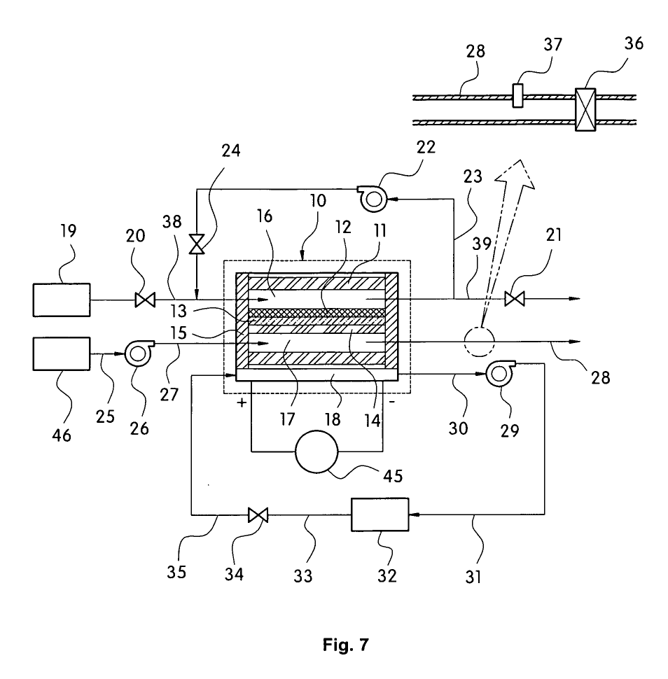

Reference will now be made in detail to the preferred embodiment of the present invention, examples of which are illustrated in the drawings attached hereinafter, wherein like reference numerals refer to like elements throughout. The embodiments are described below so as to explain the present invention by referring to FIGS. 3-7.

As discussed above, the prior art has the following problems: 1) complicated structure (resistance, hydrogen burner in hydrogen recirculation line, nitrogen tank, etc.); 2) excessive time required by the complicated startup/shutdown process; 3) degradation of durability performance due to air flowing into the anode during startup/shutdown by employing an additional device; and 4) degradation of durability performance due to fuel cell pollutants by the hydrogen exhaust and air exhaust exposed to the air.

For example, the moisture in the fuel cell may be evaporated under dry atmospheric conditions and the humidifying water of an MEA is evaporated to cause performance degradation. Moreover, when the fuel cell 10 is left for a long time, pollutants in the ambient air such as CO, HC, O₃, H₂S, etc. and organic materials infiltrate into the fuel cell 10, reducing the performance of the fuel cell 10.

The present invention aims at solving such problems of the prior art and preventing the formation of hydrogen/oxygen at the anode during startup and shutdown of the fuel cell.

in accordance with a preferred embodiment of the present invention, a pressure sensor 37 and an air discharge solenoid valve 36 are provided in an air discharge pipe 28.

In general, air is discharged from a fuel cell 10 to the outside through an air discharge pipe 28 during operation of the fuel cell 10.

During shutdown of the fuel cell 10, a terminal supplying electric power in the fuel cell 10 is short circuit and the fuel cell 10 has an open circuit voltage (OCV).

At this time, the hydrogen is continuously fed into the fuel cell 10 through the hydrogen supply valve 20 and hydrogen supply pipe 38, while the hydrogen discharge valve 21 is closed, to participate in a chemical reaction in the fuel cell 10. Unreacted residual hydrogen is then recirculated by the hydrogen recirculation blower 22.

The pressure sensor 37 detects the air pressure of the air discharge pipe 28, and a controller receiving a signal detected by the pressure sensor 37 transmits a control signal to the air blower 26 to supply air to the fuel cell 10 until a predetermined pressure is reached. When the predetermined pressure is reached, the operation of the air blower 26 is stopped and an air discharge solenoid valve 36 is closed.

In this case, the pressure may be set at an absolute pressure of 1.01 bar to 3.0 bar and, preferably, at an absolute pressure of 1.1 bar to 2.0 bar.

The reaction of hydrogen and oxygen occurring in the fuel cell 10 in accordance with a preferred embodiment of the present invention will be described below.

1. Reaction at the anode 12

Hydrogen filled in the anode 12 and a hydrogen discharge pipe 39 reacts with oxygen which has flowed from the cathode 14 to form water. That is, two H₂ molecules react with one O₂ molecule to form two H₂O molecules.

As such a reaction takes place continuously at the anode 12, the hydrogen is gradually exhausted and thus the pressure thereof is reduced.

2. Reaction at the cathode 14

Air is filled in the cathode 14 and the air discharge pipe 28 and oxygen contained in the air reacts with hydrogen which has flowed from the anode 12 to form water at the cathode 14. That is, two H₂ molecules react with one O₂ molecule to form two H₂O molecules.

As such a reaction takes place continuously at the cathode 14, the oxygen is gradually exhausted and thus the pressure thereof is reduced.

The above reactions continue until the oxygen in the air of an air supply pipe 27, a cathode flow field 17 and the air discharge pipe 28 is completely exhausted.

If the oxygen is completely exhausted, since the ratio of the oxygen in the air is about 20%, the pressure of the air supply pipe 27, the cathode flow field 17 and the air discharge pipe 28 is reduced by about 20% than the predetermined pressure.

In this case, the difference in pressure between the anode 12 and the cathode 14 is generally within ±1 bar and, preferably, within 0.5 bar.

Accordingly, since the cathode 14 is filled with nitrogen and the anode 12 is filled with hydrogen after the oxygen is completely exhausted, the formation of hydrogen/oxygen interface is not formed even though hydrogen is supplied directly from a hydrogen supply source 19, thus preventing the cathode carbon corrosion.

According to a preferred embodiment of the present invention, a pressure relief valve (PRV) 40 is provided between the air discharge solenoid valve 36 and the pressure sensor 37 to prevent over-pressure due to a malfunction of the pressure sensor or the air blower, thus protecting the MEA in the fuel cell.

The PRV 40 operates at a pressure above a predetermined pressure to shut off the air supply at high pressure.

If the amount of water generated from the hydrogen/oxygen reaction is excessive, the air discharge solenoid valve 36 can be frozen in winter.

In order to solve the above problem, according to another embodiment of the present invention, an air discharge solenoid valve 41 equipped with a hot wire may be provided in the air discharge pipe. That is, a hot wire may be provided in the air discharge solenoid valve 36.

A storage tank 42 for storing water generated from the air discharge pipe 28 may be mounted in front of the air discharge solenoid valve 41 equipped with a hot wire, and a water discharge solenoid valve 43 equipped with a hot wire may be provided below the storage tank 42 to discharge water in the storage tank 42.

The addition of the storage tank 42 and the water discharge solenoid valve 43 equipped with a hot wire is applicable to all the other embodiments of the present invention.

In accordance with a further embodiment of the present invention, there is provided an air supply solenoid valve 44 between the air blower 26 and the fuel cell 10 in order to minimize the amount of air reacting in the fuel cell 10, thus reducing the time during which the cathode 14 is filled with nitrogen.

At this time, the pressure sensor 37 detects the air pressure of the air discharge pipe 28, and the controller receiving a signal detected by the pressure sensor 37 transmits a control signal to the air blower 26 to supply air to the fuel cell 10 until a predetermined pressure is reached. When the predetermined pressure is reached, the operation of the air blower 26 is stopped, and the air discharge solenoid valve 36 and the air supply solenoid valve 44 are closed.

Likewise, the addition of the air supply solenoid valve 44 is applicable to all the other embodiments of the present invention.

In accordance with still another embodiment of the present invention, there is provided an energy storing and exhausting device 45 connected to the fuel cell 10 in order to rapidly exhaust oxygen in the air reacting in the fuel cell 10.

The energy storing and exhausting device 45 includes all electrical components such as a battery, a super capacitor, etc. capable of storing electricity.

The energy storing and exhausting device 45 may be applied to all components in the vehicle.

Accordingly, it is possible to prevent the cathode carbon corrosion due to the anode hydrogen/oxygen interface by rapidly exhausting oxygen in the air reacting in the fuel cell using the energy storing and exhausting device 45.

As described above, according to the present apparatuses, it is possible to prevent the cathode carbon corrosion, thus improving the durability and performance of the fuel cell.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for preventing carbon corrosion at the cathode of a fuel cell, the apparatus comprising:
an air blower supplying air from an air supply source to a fuel cell;
a fuel cell receiving air from the air blower to generate electricity by a chemical reaction;
an air discharge pipe through which residual air remaining after oxygen of the air is consumed for chemical reaction in the fuel cell is discharged;
a pressure sensor provided in the air discharge pipe for detecting air pressure in the fuel cell;
an air discharge solenoid valve provided in the air discharge pipe for controlling air flow of the air discharge pipe; and
a controller controlling operation of the air blower and the air discharge solenoid valve by receiving a signal detected by the pressure sensor,
wherein the controller detects the air pressure through the pressure sensor to allow the air blower to supply air to the fuel cell until the air pressure reaches a predetermined pressure and then closes the air discharge solenoid valve until the oxygen in the fuel cell is completely exhausted, thereby preventing the formation of hydrogen/oxygen interface at the anode of the fuel cell.

2. The apparatus of claim 1, further comprising a pressure relief valve (PRV) provided between the pressure sensor and the air discharge solenoid valve.

3. The apparatus of claim 1, further comprising:
a storage tank provided in the air discharge pipe to store water discharged through the air discharge pipe; and
a water discharge solenoid valve provided below the storage tank to discharge the water stored in the storage tank.

4. The apparatus of claim 3, wherein the air discharge solenoid valve is equipped with a hot wire for preventing the air discharge solenoid valve from being frozen due to water when the temperature drops below zero.

5. The apparatus of claim 3, wherein the water discharge solenoid valve is equipped with a hot wire for preventing the air discharge solenoid valve from being frozen due to water when the temperature drops below zero.

6. The apparatus of claim 1, further comprising an air supply solenoid valve provided between the air blower and the fuel cell to minimize the amount of air to be consumed for chemical reaction in the fuel cell, thereby reducing the time for which the cathode is filled with nitrogen.

7. The apparatus of claim 1, further comprising an energy storing and exhausting device connected to the fuel cell to rapidly exhaust oxygen contained in the air introduced into the fuel cell.

8. The apparatus of claim 2, further comprising:
a storage tank provided in the air discharge pipe to store water discharged through the air discharge pipe; and
a water discharge solenoid valve provided below the storage tank to discharge the water stored in the storage tank.

9. The apparatus of claim 8, wherein the air discharge solenoid valve is equipped with a hot wire for preventing the air discharge solenoid valve from being frozen due to water when the temperature drops below zero.

10. The apparatus of claim 8, wherein the water discharge solenoid valve is equipped with a hot wire for preventing the air discharge solenoid valve from being frozen due to water when the temperature drops below zero.

11. The apparatus of claim 2, further comprising an air supply solenoid valve provided between the air blower and the fuel cell to minimize the amount of air to be consumed for chemical reaction in the fuel cell, thereby reducing the time for which the cathode is filled with nitrogen.

12. The apparatus of claim 2, further comprising an energy storing and exhausting device connected to the fuel cell to rapidly exhaust oxygen contained in the air introduced into the fuel cell.

13. The apparatus of claim 3, further comprising an air supply solenoid valve provided between the air blower and the fuel cell to minimize the amount of air to be consumed for chemical reaction in the fuel cell, thereby reducing the time for which the cathode is filled with nitrogen.

14. The apparatus of claim 3, further comprising an energy storing and exhausting device connected to the fuel cell to rapidly exhaust oxygen contained in the air introduced into the fuel cell.
